(19) United States
(12) Patent Application Publication
(10) Pub. No.: US 2007/0276822 A1
(43) Pub. Date: Nov. 29, 2007

(54) POSITIONAL AND IMPLICIT CONTEXTUALIZATION OF TEXT FRAGMENTS INTO FEATURES

(75) Inventor: Brian O. Bush, Beaverton, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: RULESPACE LLC, Beaverton, OR (US)

(21) Appl. No.: 11/692,773

(22) Filed: Mar. 28, 2007

Related U.S. Application Data
(60) Provisional application No. 60/800,509, filed on May 12, 2006.

(51) Int. Cl. G06F 17/30

(52) U.S. Cl. 707/5; 707/E17.002; 707/3

(57) ABSTRACT

Embodiments of the present invention provide methods and apparatuses adapted to generate contextualized tokens to facilitate classification of text fragments.

### CROSS REFERENCE TO RELATED APPLICATIONS

The present application claims priority to U.S. Provisional Application No. 60/800,509, filed May 12, 2006, entitled “Methods and Apparatus for Positional and Implicit Contextualization of Text Fragments into Features,” the entire disclosure of which is hereby incorporated by reference in its entirety.

### TECHNICAL FIELD

Embodiments of the present invention relate to the field of wireless communication, and more specifically, to the classification of text fragments.

### BACKGROUND

Wireless communication systems are experiencing an explosive growth in popularity. This increase in popularity has led to a wider utilization of text messaging services whereby text fragments are exchanged between users. Text messages or text fragments may include any type of content ranging from a simple note to a message containing inappropriate content. Furthermore, the inappropriate content may be incorporated directly into the text message itself, or it may be in a more innocuous form, such as a web address where inappropriate content may be found. These text messages, however, often contain very little content, especially when the message is primarily a Uniform Resource Locator (“URL”). In such situations, it is extremely difficult to classify the content of the message. Without such classifications, filtering mechanisms may fail to accurately shield individuals from unwanted or inappropriate material.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates an example embodiment of a host device performing positional contextualization in accordance with various embodiments of the present invention;

FIG. 2 illustrates an example embodiment of a host device performing implicit contextualization in accordance with various embodiments of the present invention;

FIG. 3 illustrates an example embodiment of a contextualization of a Uniform Resource Locator (“URL”);

FIG. 4 illustrates a block diagram of an exemplary device capable of implicit and positional contextualization in accordance with various embodiments of the present invention; and

FIG. 5 illustrates a flow diagram view of a portion of the operations of a host device in accordance with various embodiments of the present invention.

### DETAILED DESCRIPTION OF EMBODIMENTS OF THE INVENTION

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments of the present invention, methods, apparatuses, and systems to facilitate the classification of text fragments are provided. More specifically, techniques, systems and apparatuses for performing implicit and positional contextualization of text fragments are disclosed. The gain from this contextualization is that as much information is extracted from a text fragment as possible. In this manner, every available piece of information may be utilized to generate a feature set which is then capable of classification. Such a classification, for example, may notify a user that the text fragment contains inappropriate material, or conversely, no inappropriate material. The inventive techniques may be implemented in any device suitably configured for receiving text fragments including but not limited to: cellular devices, smart phones, personal digital assistants (“PDAs”), personal computers, and other networked devices. The invention is not to be limited in this regard.

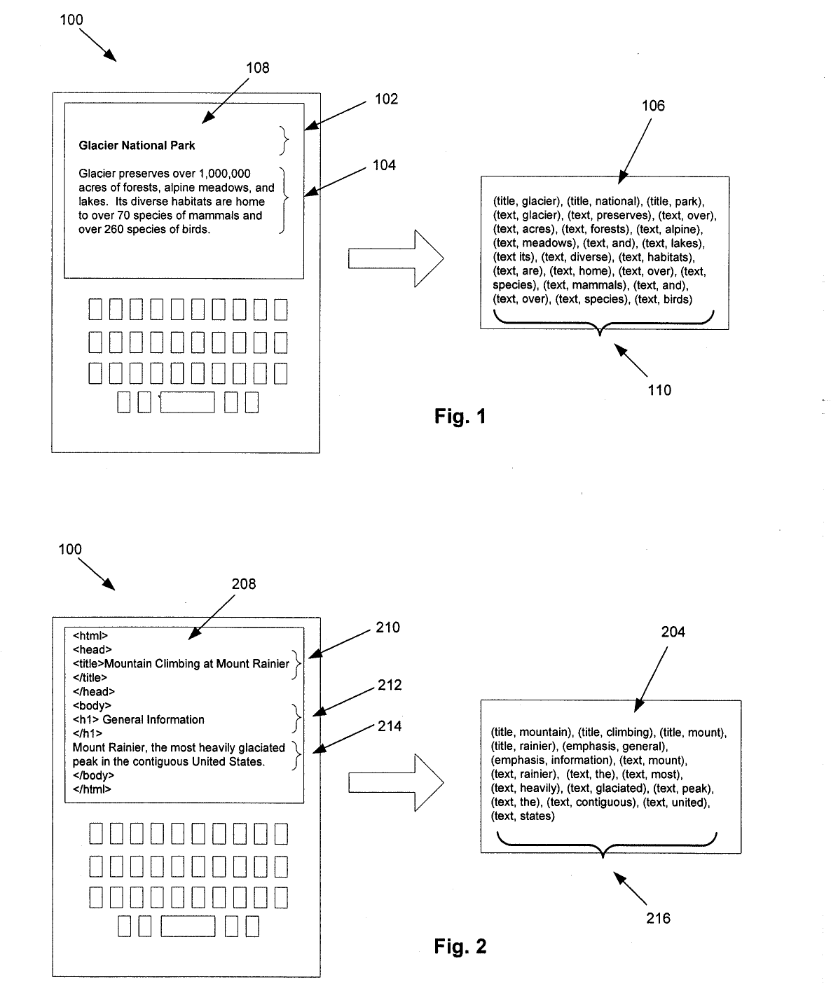

Referring now to FIG. 1, a diagram of an exemplary host device performing positional contextualization, in accordance with various embodiments of the present invention, is illustrated. FIG. 1 includes a host device 100, a text fragment 108, contextualized tokens 106, and a feature set 110.

In the illustrated embodiment, the host device 100 which, as stated previously, may be any device suitably configured for receiving wireless or wired text fragments, receives a text fragment 108. The text fragment 108, in the illustrated embodiment, is a wireless document having a layout structure which includes a title 102, and a body of text 104. Upon receiving the text fragment 108, the host device 100 may generate individual contextualized tokens 106. Contextualized tokens may be generated using implicit contextualization, which will be discussed more fully herein, or positional contextualization. In the illustrated embodiment, the host device 100 utilizes positional contextualization to contextualize each term within the text fragment 108. More specifically, in the illustrated embodiment, the host device 100 generates a contextualized token 106 by effectively pairing a term with its positional context, i.e., title or text. In the illustrated embodiment, the host device 100 ignores punctuation, case, and terms less than three characters. In various other embodiments these guidelines may be modified. The host device 100 may then determine a feature set 110 based on the contextualized tokens 106. The feature set 110 may then be used, in various embodiments, to facilitate classification of the text fragment 108. In the illustrated embodiment, the contextualized token includes a term from the text fragment 108 and its respective positional context. It is contemplated, however, that a contextualized token may include any number of terms and/or any number of respective contexts.

In various other embodiments, the text fragment 108 may be a Short Message Service (“SMS”) message, a chat message, a Uniform Resource Locator (“URL”), and/or any other form of wirelessly or wired received text. Additionally, within each of the various embodiments, the text fragment 108 may also utilize formatting characteristics including, but not limited to: layout structures, text formatting, text coloring, punctuation, various case usage, unique number sequences, images, and/or links. In certain embodiments these characteristics may be used to facilitate positional contextualization of the text fragments. For instance, in one embodiment, a host device 100 may receive a URL and utilize the contexts inherent in a URL, such as: a server, a path, a filename, and a file_type. In another embodiment, a host device 100 may receive an SMS message and utilize contexts that utilize human notions such as: first_sentence, URL, text, and upper_case_text. In still another embodiment, the host device 100 may receive a chat message, and utilize contexts including: URL, text, or upper_case.

Referring now to FIG. 2, a diagram of an exemplary host device performing implicit contextualization, in accordance with various embodiments of the present invention, is illustrated. FIG. 2 includes a host device 100, a text fragment 208, contextualized tokens 204, and a feature set 216.

In the illustrated embodiment, the host device 100 which, as stated previously, may be any device suitably configured for receiving wireless or wired text fragments, receives a text fragment 208. The text fragment 208, in the illustrated embodiment, is a Hypertext Markup Language (“HTML”) webpage. In various embodiments, the HTML webpage does not display the source code, but rather only the web page. In such instances, the HTML code may remain available to the host device 100. In the illustrated embodiment, the HTML code in text fragment 108 contains the components “<title>” 210, “<h1>” 212, and “<body>” 214. Upon receiving the text fragment 208, the host device 100 may then generate individual contextualized tokens 204. In the illustrated embodiment, the host device 100 utilizes implicit contextualization to contextualize each term within the text fragment 208. More specifically, in the illustrated embodiment, the host device 100 generates a contextualized token 204 by effectively pairing a term with its implicit context, i.e., the title (<title>) 210, emphasis (<h1>) 212, or text (<body>) 214, within the HTML code. In the illustrated embodiment, the host device 100 ignores punctuation, case, and terms less than three characters. In various other embodiments, these guidelines may be modified. The host device 100 may then determine a feature set 216 based on the contextualized tokens 204. The feature set 216 may then be used, in various embodiments, to facilitate classification of the text fragment 208. In the illustrated embodiment, the contextualized token includes a term from the text fragment 208 and its respective implicit context. It is contemplated, however, that a contextualized token may include any number of terms and/or any number of respective contexts. In various other embodiments, implicit contextualization may be applied to other document formats, and/or other programming languages.

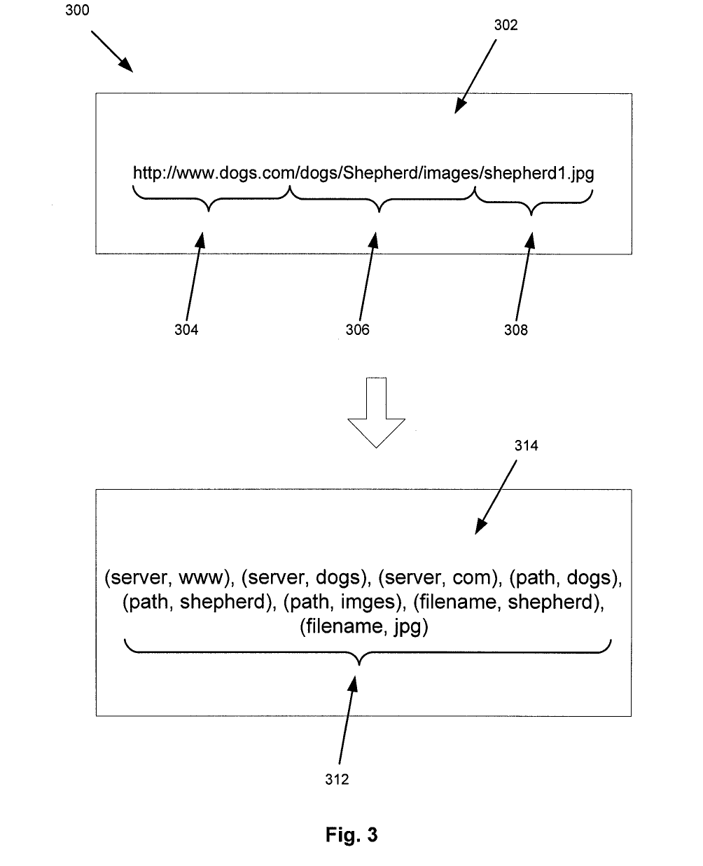

Referring to FIG. 3, a screen shot 300 of a text fragment 302 is illustrated. In the illustrated embodiment, the text fragment 302 includes a Uniform Resource Locator (“URL”). The URL, in various embodiments, may be contextualized using either positional and/or implicit contextualization. Utilizing positional contextualization, in the illustrated embodiment, three contexts are defined: server 304, path 306, and filename 308. In various embodiments, as described earlier, each term may then be contextualized into contextualized tokens 314 with its respective context, i.e., server 304, path 306, or filename 308. In the illustrated embodiment numbers are stripped from the contextualized tokens; however, in various other embodiments these guidelines may be modified. Following the generation of the contextualized tokens 314, the host device (not shown) may then determine a feature set 312. The feature set 312 may be used to facilitate classification of the URL. For instance, in the illustrated embodiment, the term “dogs” appears two times, once in the server 304 portion, and once in the path 306 portion. In the illustrated embodiment, the contextualized tokens 312 retain the respective context of each occurrence, and therefore, may allow a classification scheme to utilize this differentiation to facilitate accurate classification.

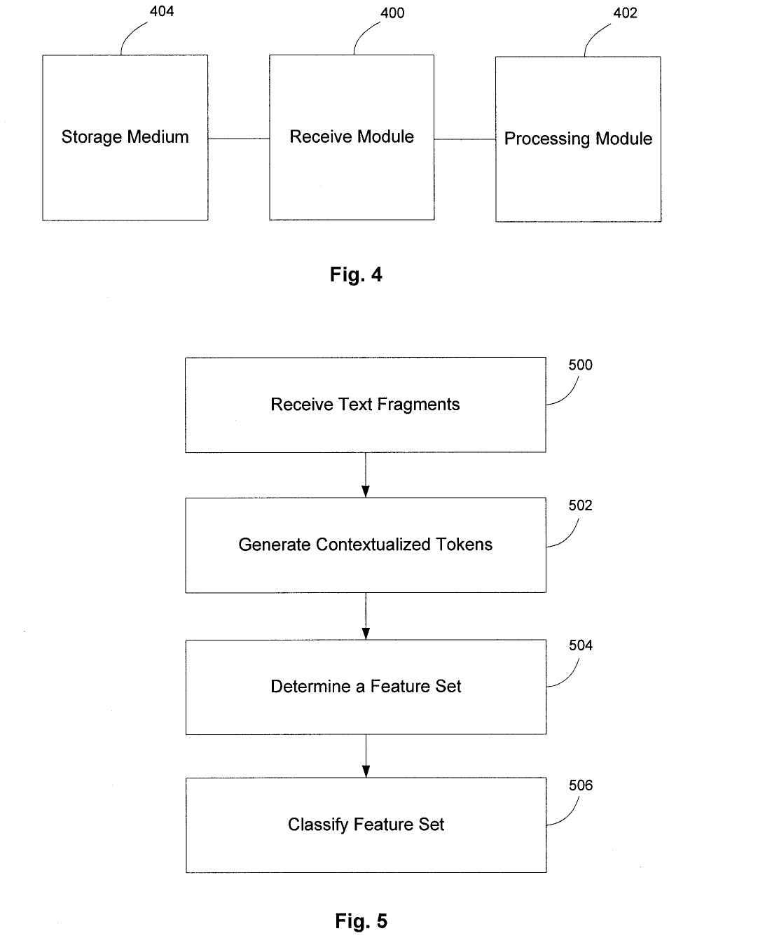

Referring now to FIG. 4, a simplified block diagram of an exemplary arrangement, housed within a host device, capable of implicit and positional contextualization in accordance with various embodiments of the present invention is illustrated. In one embodiment, a storage medium 404 functions to store a plurality of programming instructions that enable a device to receive text fragments, and generate contextualized tokens. In the illustrated embodiment, a storage medium is operatively coupled to a receive block 400. The receive block functions to receive, wirelessly or wired, text fragments. In various embodiments the text fragments may be a wireless document, a Short Message Service (“SMS”) message, a chat message, a Uniform Resource Locator (“URL”), and/or any other form of wirelessly or wired received text. The receive module 400 is operatively coupled to a processing module 402. In one embodiment, the processing module generates the contextualized tokens consisting of at least a term of the text fragment and at least one context of the respective term. The contextualized token may then be used to determine a feature set. In various embodiments, the feature set may be used to facilitate classification of the text fragment. Such a classification, in various embodiments, may serve to inform a user of the host device of the presence of absence of inappropriate content, or in other embodiments may simply shield the user from any inappropriate content.

Referring to FIG. 5, a flow diagram view of a portion of the operations of a host device in accordance with various embodiments of the present invention is illustrated. In various embodiments these steps may be performed by any one of a cellular phone, mobile phone, personal digital assistant (“PDA”), and/or any other device capable of sending or receiving text messages or text fragments. In one embodiment, the host device receives a text fragment at block 500. The host device may then generate contextualized tokens at block 502. In various embodiments, the contextualized tokens may be generated using positional contextualization and/or implicit contextualization. In still other embodiments, the contextualized tokens may include any number of contexts. At block 504, the host device may then determine a feature set based on at least the contextualized tokens. In various embodiments the feature set may be used to facilitate classification of the text fragment at block 506.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method, comprising:
receiving, by a device, a text fragment;
generating, by the device, contextualized tokens, wherein a contextualized token includes at least a term from the text fragment and at least a context of the term; and
determining, by the device, a feature set, based on at least the contextualized tokens, to facilitate classification of the text fragment.

2. The method of claim 1, wherein the receiving comprises receiving one of a wireless document, a Short Message Service (“SMS”) text message, a chat message, or a Uniform Resource Locator (“URL”).

3. The method of claim 1, wherein the generating comprises using implicit contextualization to generate the contextualized tokens.

4. The method of claim 1, wherein the generating comprises using positional contextualization to generate the contextualized tokens.

5. The method of claim 1, wherein the text fragment further comprises at least one of a layout structure, text formatting, text coloring, punctuation, case usage, unique numeric sequences, an image, or a link count.

6. The method of claim 1, wherein the receiving comprises receiving a text fragment including a URL; and
the generating comprises generating contextualized tokens wherein the context of the term is one of a scheme, a server, a path, or a filename.

7. The method of claim 1, wherein the generating comprises generating contextualized tokens wherein the context of the term is one of a title, a link, an image, an emphasis, a size, a media type, a URL, or a unique number sequence.

8. An apparatus comprising:
a receive module configured to receive a text fragment; and
a processing module, operatively coupled to the receive module, configured to generate contextualized tokens, wherein a contextualized token includes at least a term from the text fragment and at least a context of the term to facilitate classification of the contextualized token.

9. The apparatus of claim 8, wherein the processing module is further configured to determine a feature set based on at least the contextualized tokens to facilitate classification of the text fragment.

10. The apparatus of claim 8, wherein the receive module is configured to receive one of a wireless document, a Short Message Service (“SMS”) text message, a chat message or a Uniform Resource Locator (“URL”).

11. The apparatus of claim 8, wherein the processing module is configured to use implicit contextualization to generate the contextualized token.

12. The apparatus of claim 8, wherein the processing module is configured to use positional contextualization to generate the contextualized token.

13. The apparatus of claim 8, wherein the at least a context of the term includes one of a layout structure, text formatting, text coloring, punctuation, case usage, unique numeric sequences, an image, and/or a link count.

14. An article of manufacture comprising:
a storage medium; and
a plurality of programming instructions stored on the storage medium and designed to enable a device to:
receive a text fragment; and
generate contextualized tokens, wherein a contextualized token includes at least a term from the text fragment and at least a context of the term, to facilitate classification of the text fragment.

15. The article of manufacture of claim 14, wherein the programming instructions are further designed to enable the device to receive a text fragment wherein the text fragment is one of a Short Message Service (“SMS”) text message, a chat message, or a Uniform Resource Locator (“URL”).

16. The article of manufacture of claim 14, wherein the programming instructions are further designed to enable the device to generate a contextualized token by using implicit contextualization.

17. The article of manufacture of claim 14, wherein the programming instructions are further designed to enable the device to generate a contextualized token by using positional contextualization.

18. A system comprising:
a network interface;
a receive module, coupled to the network interface, configured to receive a text fragment; and
a processing module, operatively coupled to the receive module, configured to generate contextualized tokens, wherein a contextualized token includes at least a term from the text fragment and at least a context of the term, to facilitate classification of the text fragment.

19. The system of claim 18, wherein the receive module is configured to receive a Short Message Service (“SMS”) text message, a chat message, or a Uniform Resource Locator (“URL”).

20. The system of claim 18, wherein the processing module is further configured to determine a feature set based on at least the contextualized tokens.
